(19) United States
(12) Patent Application Publication
(10) Pub. No.: US 2003/0046543 A1
(43) Pub. Date: Mar. 6, 2003

(54) Autograph and memorabilia authentication process and model

(76) Inventors: James Alan Houston, Summersville, SC (US); Nicholas Puchetti, Charleston, SC (US); Julie Ilardo-Gonzales, Franklin, TN (US)

Correspondence Address: T. Peige Wise, Adams, Schwartz & Evans, P.A., 2180 Two First Union Center, Charlotte, NC, 28282, US

(21) Appl. No.: 09/948,311

(22) Filed: Sep. 6, 2001

(51) Int. Cl. H04L 9/00

(52) U.S. Cl. 713/176

(57) ABSTRACT

A method for verifying the authenticity of a preselected item is provided which includes the steps of selecting authenticity indicia for association with the preselected item and associating the authenticity indicia with the preselected item. Digital data is then generated containing evidence of the preselected item and the authenticating indicia associated therewith. A digital file is also generated which contains digital data. The digital file is downloaded to a server associated with the Internet using software downloaded to a computer associated with the server, which permitting the digital data to be accessed from the Internet using Internet data accessing techniques. The method also includes the step of providing a Web site maintained by an authenticating party and accessible by a requesting party using the Internet data accessing techniques for permitting the requesting party to retrieve the digital file and confirm the authenticity of the preselected item.

### TECHNICAL FIELD AND BACKGROUND OF THE INVENTION

This invention relates to a process and model for documenting and verifying the authenticity of autographs and other memorabilia. While the particular embodiment of the invention described in the application is shown being used to authenticate certain sports memorabilia and any autographs which may be placed thereon, the invention has application in any setting where accurately documenting and verifying the authenticity of memorabilia, autographs, or other valuable items is required.

Prior methods of documenting the authenticity of sports memorabilia or any autographs that may be associated therewith involve the use of various types of proprietary written records or other documents which are often used in combination with numeric labels attached to the memorabilia. While these methods provide a written history regarding a specific item which an owner or other individual may later use to document the authenticity of the item, the methods do not provide a fail-proof way for the owner to ensure that the authenticating documents have not been forged, stolen, or otherwise altered. Even if proprietary labels are placed on the item, such labels fail to provide a way for the owner of the item to accurately record the moment the item was autographed or otherwise procured. Regardless of the number of “verifying” documents created or the type of label placed on the item, such written documents and labels not only fail to provide a complete record evidencing the authenticity of the autograph or item, but also fail to ensure that the documentation made available to the owner has been securely maintained and thus accurately represents the prior chain of ownership of the autograph or item. Written documents and labels also fail to offer an owner a way to periodically access proprietary data or other documentation related to an item which may be stored at a remote location to affirm whether the data or documents are being properly maintained and updated to reflect any changes in ownership.

The process and model of the present invention use a multimedia approach to authenticate autographs and memorabilia by combining the advantages afforded by information technology with conventional authentication techniques. Specifically, the invention uses the Internet, digital photography, streaming digital audio and video, and other conventional forms of information technology in combination with written documentation and proprietary labels in a manner that ensures that records evidencing the authenticity of an item are preserved and securely maintained. The present invention also permits the owner of an authenticated item to access the Internet and download data that verifies the authenticity of the item (e.g., streaming digital video showing an athlete autographing an item and photographs depicting the autographed item) by showing images of those events which were recorded at the time the events took place.

### SUMMARY OF THE INVENTION

It is therefore an object of the invention to provide an autograph and memorabilia authentication and certification service available via the Internet.

It is another object of the invention to provide a system that employs a Web site for use in verifying the authenticity and ownership of an autograph or other memorabilia.

It is another object of the invention to provide a Web site that permits an individual or entity to verify the authenticity of an autograph or other memorabilia by accessing data available through the Web site.

It is another object of the invention to provide a Web site that permits an individual or entity to download data from the Internet and to a conventional computer for verifying the authenticity of an autograph or other memorabilia.

It is another object of the invention to provide a system that utilizes a Web site to which access is restricted to specific individuals by using conventional information technology security measures for ensuring the integrity of the data available through the Web site.

It is another object of the invention to provide a system utilizing a Web site for permitting an individual to verify the authenticity of an item from a remote location.

It is another object of the invention to provide a system for verifying the authenticity and ownership of an autograph or other memorabilia that utilizes a uniquely labeled, tamper-proof, proprietary prismatic label which is associated with a specific one of a number of autographs or other memorabilia and is used to identify all data and documents evidencing the authenticity of the specific autograph or item.

These and other objects of the present invention are achieved in the preferred embodiments disclosed below by providing a method for verifying the authenticity of a preselected item. The method includes the steps of selecting an authenticating indicium for association with the preselected item and associating the authenticating indicia and associating the authenticating indicia therewith. Digital data is generated containing evidence of the preselected item and the authenticating indicia associated therewith. A digital file is then generated which contains the digital data. The digital file is downloaded to a server associated with the Internet using software that has been downloaded to a computer associated with the server. The digital file is downloaded to the server for permitting the digital data to be accessed from the Internet using Internet data accessing techniques. The method also includes providing a Web site maintained by an authenticating party and accessible by a requesting party using the Internet data accessing techniques for permitting the requesting party to retrieve the digital file and confirm the authenticity of the preselected item.

According to another preferred embodiment of a method according to the invention, the step of generating digital data further includes the step of providing an interactive event to provide a forum for authenticating the preselected item.

According to yet another preferred embodiment of a method according to the invention, the step of providing the Web site further comprises providing a preselected password to the requesting party for permitting the requesting party to access the Web site.

According to yet another preferred embodiment of a method according to the invention, the digital data is selected from the group consisting of a digital photograph, digital streaming video, digital streaming audio, and supporting textual information.

According to yet another preferred embodiment of a method according to the invention, the digital data includes at least one digital photograph, digital streaming video, digital streaming audio, and supporting textual information.

According to yet another preferred embodiment of a method according to the invention, the preselected item is an autographed item.

According to yet another preferred embodiment of a method according to the invention, the preselected item is a three-dimensional object.

According to yet another preferred embodiment of a method according to the invention, the three-dimensional object is an athletic item.

According to yet another preferred embodiment of a method according to the invention, the athletic item is selected from the group consisting of a ball, a garment, and an implement.

According to another preferred embodiment of a method according to the invention, an authentication model is provided. The model includes an interactive event administered by an authenticating party for providing a forum in which at least one preselected item is authenticated by associating authenticating indicia with the preselected item. The model also includes digital data generated during the interactive event for documenting the association of the authenticating indicia with the preselected item. At least one digital file containing the digital data is downloaded to a server associated with the Internet using commercially-available software. The software is downloaded to a computer associated with the server for permitting the digital data to be accessed from the Internet using common Internet data accessing techniques. The model also includes an on-line Web site maintained by the authenticating party and accessible by a requesting party using the common Internet accessing techniques for retrieving the at least one digital file, thereby confirming the authenticity of the preselected item.

According to yet another preferred embodiment of the invention, the model includes a preselected password provided by the authenticating party to the requesting party for permitting the requesting party to access the Web site.

According to yet another preferred embodiment of the invention, the digital data is selected from the group consisting of a digital photograph, digital streaming video, digital streaming audio, and supporting textual information.

According to yet another preferred embodiment of the invention, the digital data includes at least one digital photograph, digital streaming video, digital streaming audio, and supporting textual information.

According to yet another preferred embodiment of the invention, the preselected item is an autographed item.

According to yet another preferred embodiment of the invention, the preselected item is a three-dimensional object.

According to yet another preferred embodiment of the invention, the three-dimensional object is an athletic item.

According to yet another preferred embodiment of the invention, the athletic item is selected from the group consisting of a ball, a garment, a helmet, and an implement.

### BRIEF DESCRIPTION OF THE DRAWINGS

Some of the objects of the invention have been set forth above. Other objects and advantages of the invention shall appear as the description proceeds when taken in conjunction with the following drawings, in which:

FIG. 1 is an illustrative view of a digital photograph depicting a public autograph signing event and showing the manner in which digital data is generated according to one preferred embodiment of the present invention for later use in verifying the authenticity of an autographed item;

FIG. 2 is an illustrative view of a digital photograph depicting the autograph signing event shown in FIG. 1 and illustrating the manner in which digital data is generated evidencing the association of an identifying sign with a celebrity and an item as the item is being autographed;

FIG. 3 is an illustrative view of a digital photograph depicting a celebrity autographing sports memorabilia;

FIG. 4 is an illustrative view of a digital photograph depicting the association of identifying indicia with an autographed item of sports memorabilia;

FIG. 5 is a screen shot of a Web page according to the present invention showing a partial front elevation of a baseball to which authenticating indicia has been attached according to the present invention;

FIG. 6 is a front elevation of a proprietary card according to one embodiment of the present invention;

FIG. 7 is a sample of a form used for documenting the ownership history of an item authenticated using a preferred method of the present invention;

FIG. 8 is an illustrative view of a frame isolated from a digital streaming video clip showing a sign containing information identifying a celebrity who is autographing items;

FIG. 9 is an exploded view of a football jersey being cut into segments;

FIG. 10 is an exploded view of a basketball net being cut into segments;

FIG. 11 is a flow chart depicting part of one preferred method and system of the present invention;

FIG. 12 is a screen shot of a home page of a Web site according to the present invention;

FIG. 13 is a screen shot of another page of the Web site shown in FIG. 12;

FIG. 14 is a screen shot of another page of the Web site shown in FIG. 12;

FIG. 15 is a screen shot of another page of the Web site shown in FIG. 12; and

FIG. 16 is a partial view of another page of the Web site shown in FIG. 12.

The patent or application file contains at least one drawing executed in color. Copies of this patent or patent application publication with color drawing(s) will be provided by the Office upon request and payment of the necessary fee.

### DESCRIPTION OF THE PREFERRED EMBODIMENT AND BEST MODE

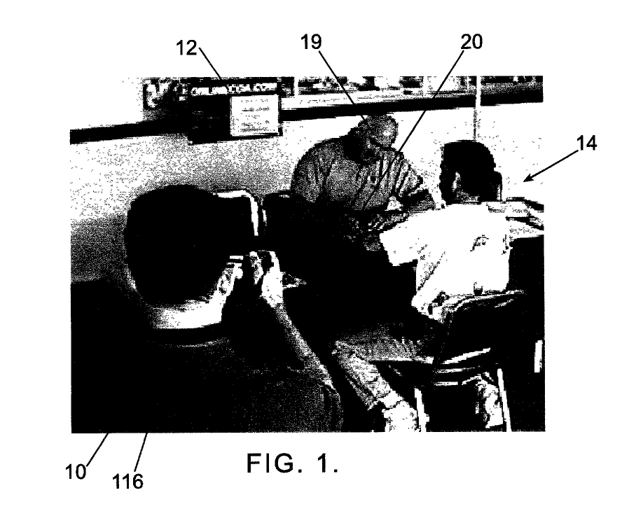

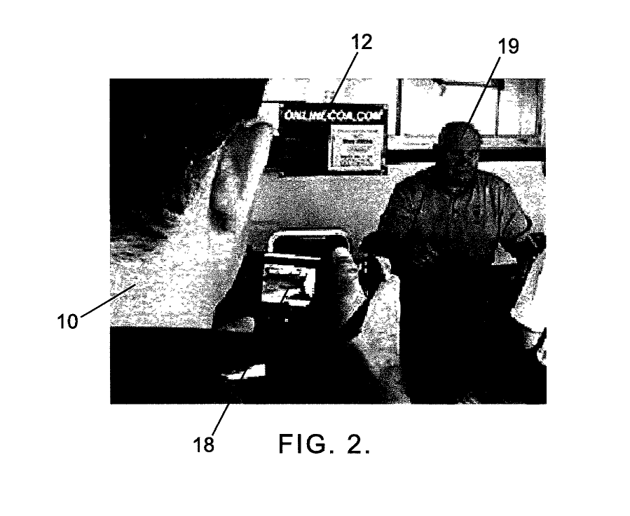

Referring now specifically to the drawings, FIG. 1 illustrates an embodiment of the authentication method and system of the present invention in which one of a number of representatives 10 of an authentication company or organization 12 is shown at an interactive event 14 using a digital camera 16 to collect digital data 18 (see FIG. 2) documenting a retired athlete 19 autographing sports memorabilia 20. While the interactive event 14 at which the authentication method and system shown in FIG. 1 is a public signing event, as discussed in detail below, the authentication method and system of the present invention may also be used at an interactive event 14 such as a private autograph signing or an interactive event 14 in which the authenticity of a particular piece of memorabilia, such as a segment taken from the hood of a NASCAR driver's car, needs to be documented and verified.

Public Signing Events

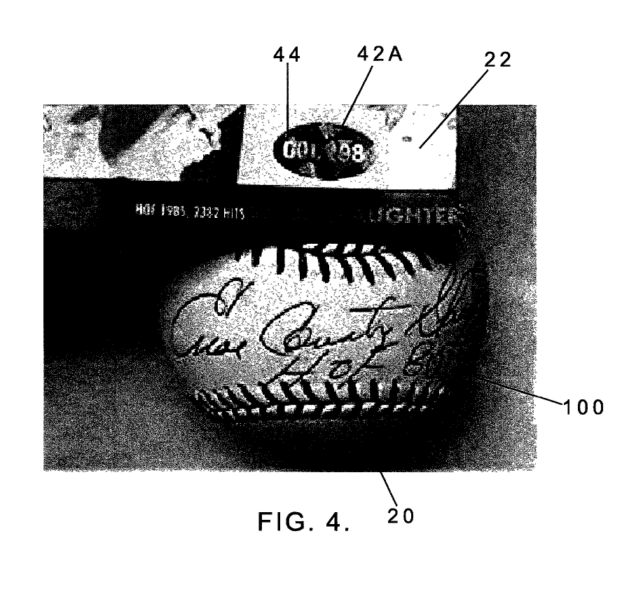

Referring now to FIG. 2, a typical public signing event is sponsored and managed by a promoter or other entity, and features several active and/or retired athletes, sports celebrities, or other public figures (hereinafter collectively referred to as “celebrity” or “celebrities”) 19, each of whom appears at the signing event for a predetermined period of time during which members of the general public present various sports memorabilia 20 to the celebrities 19 for autographs (see FIG. 1). An individual attending a public signing event typically obtains an autograph by purchasing an autograph ticket 22 in a manner similar to that in which a conventional movie theater ticket is purchased. A representative sample of a portion of an autograph ticket 22 is shown in FIG. 4. The price of an autograph ticket 22 varies depending upon the present and predicted future market value of the autograph being purchased. Once the autograph ticket 22 has been purchased, the ticket 22 and item 20 are presented to the celebrity 19, and the celebrity 19 autographs the item 20 (see FIG. 1).

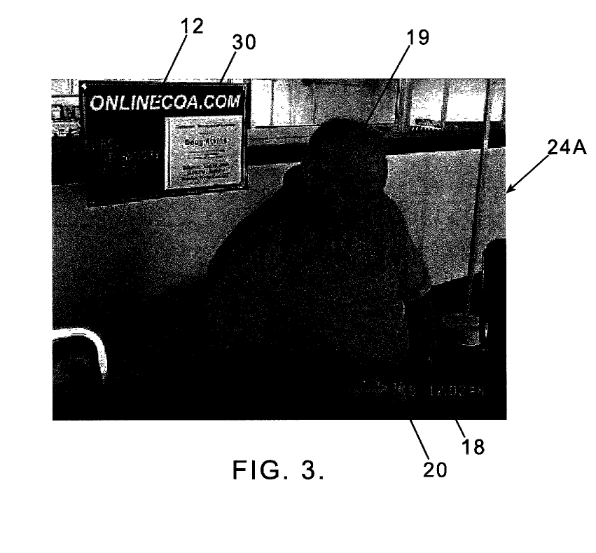

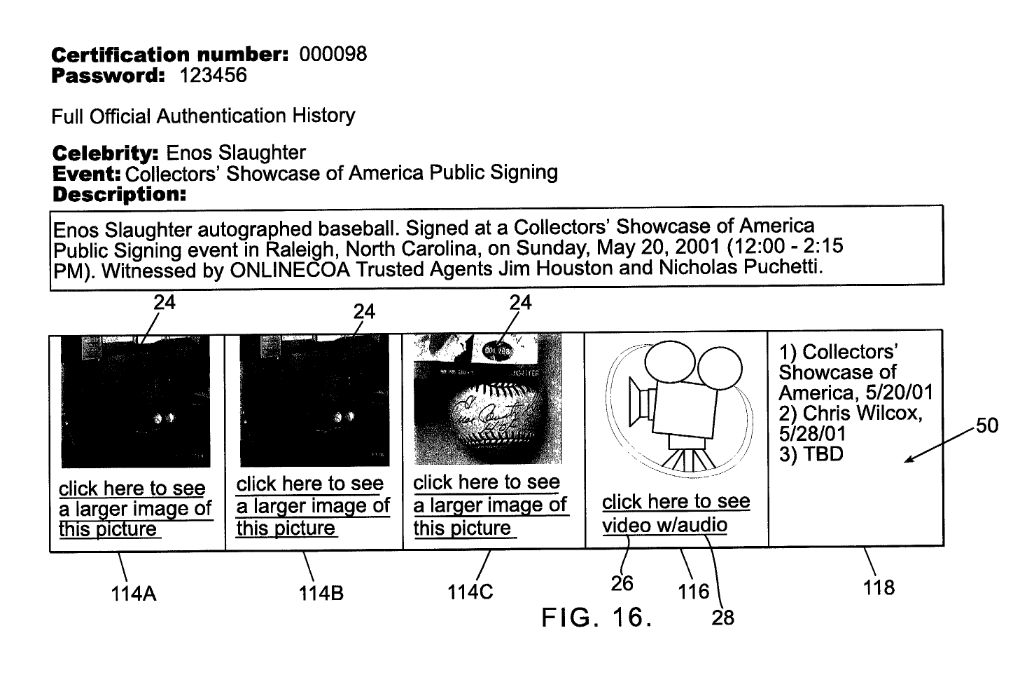

As shown in FIGS. 1 and 2, during the public signing event, a representative 10 of the authentication company 12 gathers digital data 18 in the form of digital photographs 24, streaming digital video 26, streaming digital audio 28 (see FIG. 16) and the like of each celebrity 19 as the celebrity 19 autographs various items 20. This “generic” digital data 18 is used as supplemental evidence verifying the authenticity of each autographed item 20. As is shown in FIG. 3, the digital data 18 includes at least one digital photograph 24A featuring both the celebrity 19 and a sign or other easy-to-read chart or poster 30 upon which information identifying the event and the celebrity 19 is printed. Information set forth on the sign 30 also preferably includes, but is not limited to, the name of the authenticating company 12 and the date, time, and location of the public signing event.

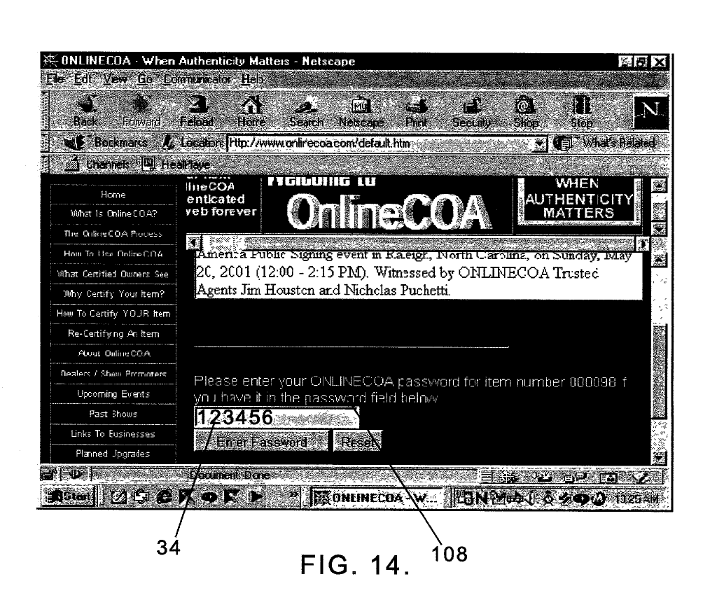

After the item 20 has been autographed, the autographed item 20 and corresponding autograph ticket 22 are presented to a representative 10 of the authenticating company or organization 12. The representative 10 records the name of the owner of the autographed item 20 and assigns a unique password 34 to the owner (a sample password 34 is shown in FIG. 14). The password 34 may be arbitrarily assigned or chosen by the owner, and associates the autographed item 20 with the name of the owner and any other identifying information which has been gathered by the representative 10. As discussed in detail below in reference to FIG. 14, the password 34 is later used by the owner or any other entity authorized by the owner of the item 20 to enter a Web site for accessing digital data 18 documenting the authenticity of the autographed item 20. The date, time and location of the event, along with the name(s) of the representative(s) 10 are also recorded.

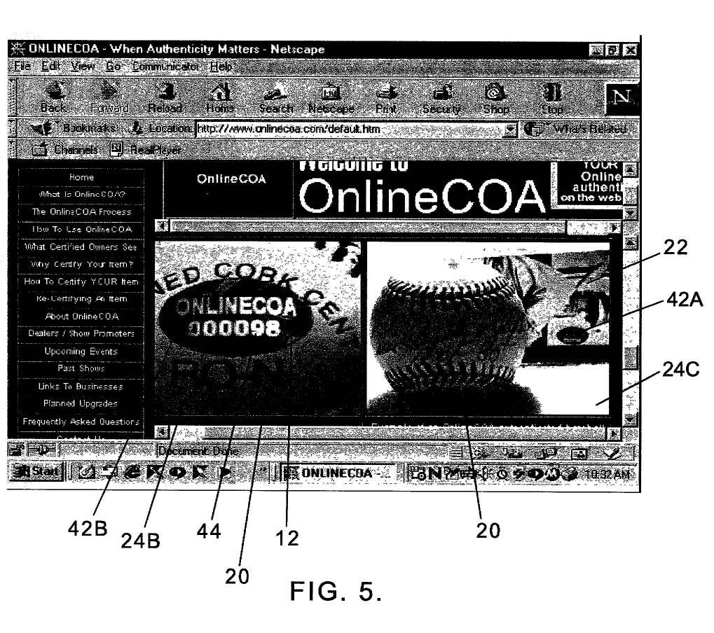

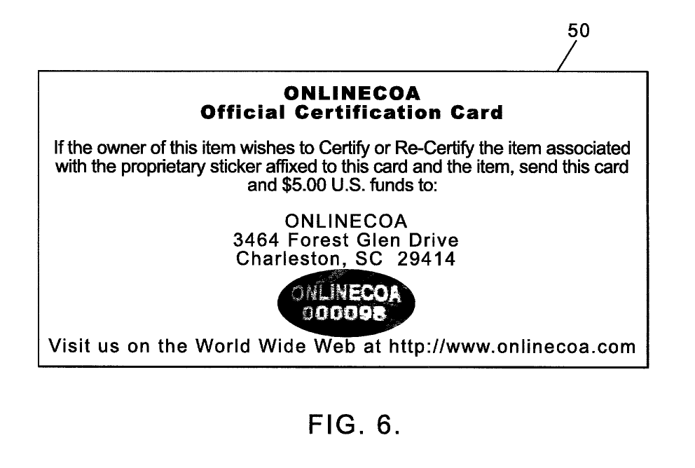

Referring now to FIGS. 4 and 5, once the identifying information has been gathered and the password 34 assigned, two identical labels 42A and 42B are assigned to the autographed item 20. Although any suitable label may be used, each label 42A and 42B is preferably tamper-proof and includes an outwardly-facing surface coated with prismatic material and an inwardly-facing surface coated with an adhesive substance. The name of the authenticating company 12 and a preselected tracking number 44 are printed on the prismatic surface of each label 42A and 42B, respectively. As shown in FIG. 5, one of the labels 42A or 42B is attached directly to a surface of the autographed item 20. The other label 42A or 42B is attached to either the autograph ticket 22 (see FIG. 4) or another proprietary card 50 (see FIG. 6). Digital photographs 24B and 24C showing the labeled item and the autographed item 20 with the labeled autograph ticket 22, respectively, are then taken by the authenticating representative 10.

Referring now to FIG. 6, a representative sample of a labeled proprietary card 50 is shown. Utilized primarily at private signing events, the card 50 may be used in the event the autographed item 20 is recertified or otherwise transferred to another owner. To recertify an item 20 or report a transfer of ownership, the owner submits the card 50 and a predetermined sum of money to the authentication company 12. Upon receipt of the card 50 and money, the company re-certifies the item 20 or records the transfer of ownership pursuant the owner's instructions, and updates all records related to the item 20 to reflect the same.

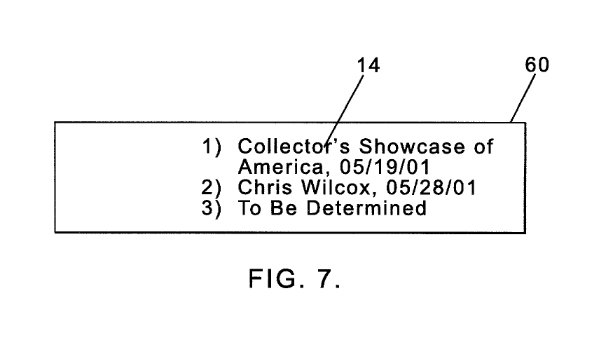

Referring now to FIG. 7, after digital photographs have been recorded and the identifying information gathered, a certified ownership history document 60 is created. While the certified ownership history document 60 may include any textual or pictorial information relevant to documenting the ownership of the autographed item 20, as shown in FIG. 7, each certified ownership history document 60 preferably includes information such as the name of the event 14 and the date upon which the event 14 occurred, along with the name or names of the owners of the autographed item 20.

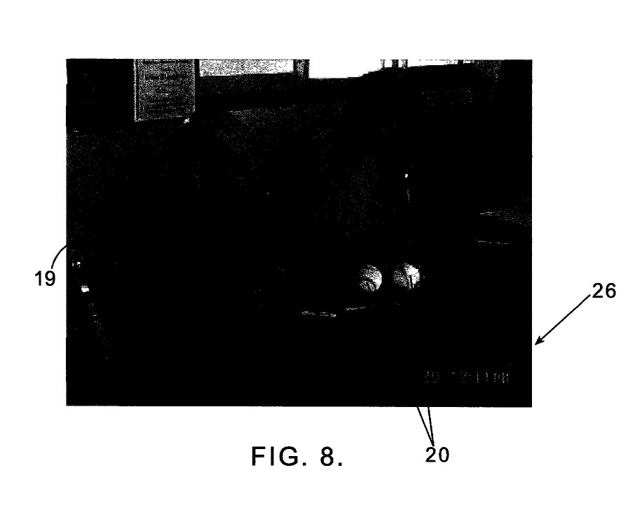

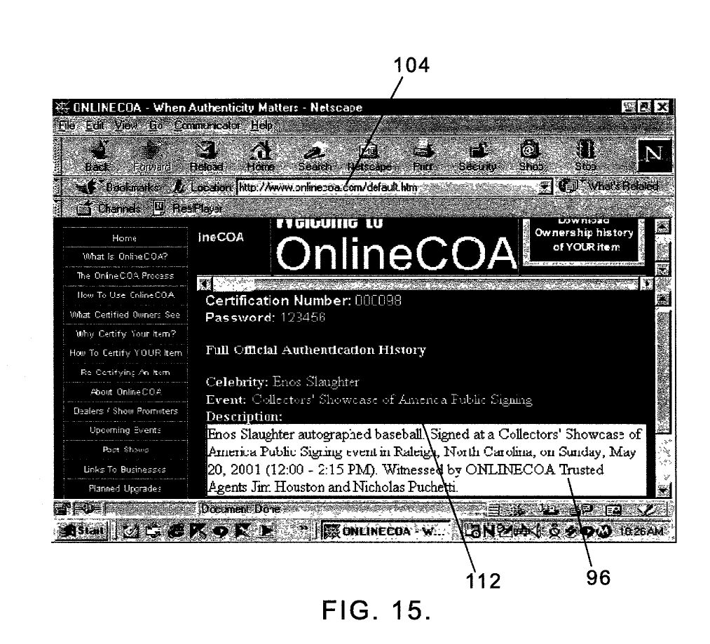

In addition to receiving a certified ownership history document 60, the owner is also given a “generic” video which includes preselected “generic” digital data 18 gathered as described above in reference to FIGS. 1 and 2. Each generic video includes streaming digital video data 26 and streaming digital audio data 28 (see FIG. 15), preferably plays for ten to thirty seconds, and illustrates the celebrity 19 who autographed the item 20 autographing a like item. A representative sample of a single frame of streaming digital video data 26 is shown in FIG. 8.

Private Signing Events

Another interactive event 14 at which the method and system of the present invention may be used is a private signing event. Private autograph signing events are conducted in a manner similar to that of public signing events. However, unlike public signing events, a private signing event is not open to the public; therefore, autograph tickets like the ticket 22 shown in FIG. 4 are not sold or distributed.

A typical private signing event is sponsored by an individual or corporate entity that wishes to authenticate a large volume of autographed items and then sell the authenticated items to the general public. During a private signing event, a representative of the authentication company gathers digital data in a manner identical to that in which digital data 18 is gathered at a public signing event. Specifically, the digital data is gathered in the form of digital photographs, streaming digital video, streaming digital audio and the like of the celebrity as the celebrity autographs each item. Once each item has been autographed, identifying information is gathered for each item, including but not limited to, the date, time, and location of the private signing event, and the name(s) of the representative(s) 10 and the celebrity who signed the item. A unique password is then assigned to the item. Like the password 34, the password may be used later by an owner of the item to enter a Web site for accessing digital data for verifying the authenticity of the autographed item.

After the identifying information has been gathered and the password assigned, two identical labels like the labels 42A and 42B shown in FIGS. 4 and 5, respectively, are assigned to each autographed item. Like the labels 42A and 42B, each of the labels are preferably tamper-proof and includes an outwardly-facing surface coated with prismatic material and an inwardly-facing surface coated with an adhesive substance. The name of the authenticating company or organization and a preselected tracking number are printed on the surface of each of the labels. One of the labels is then attached to a surface of the autographed item. The other label is attached to a certification card such as the certification card 50 shown in FIG. 6. The certification card is transferred with the autographed item at the time the item is sold, and serves as proof of the authenticity and ownership of the item. Information printed or placed on the certification card preferably includes, but is not limited to, the label bearing the tracking number, the identifying information, and instructions regarding the procedure to be followed in the event a subsequent transfer of ownership of the item takes place.

Authentication of Sports Memorabilia or Segments Thereof

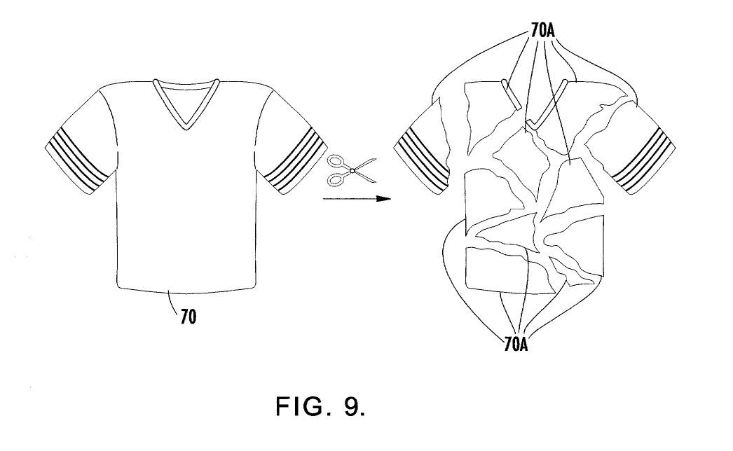

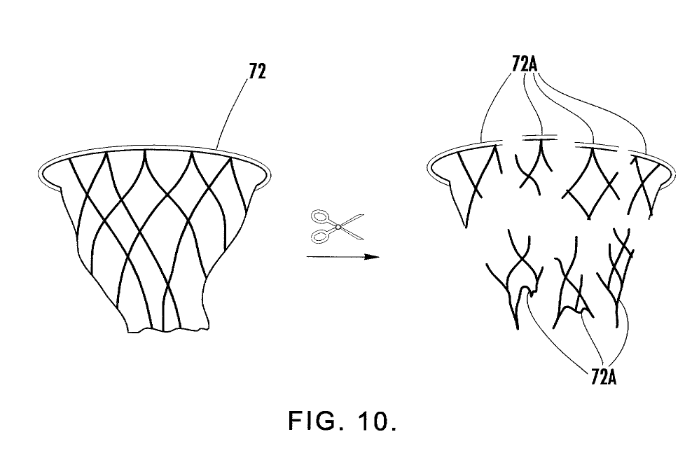

Referring now to FIGS. 9 and 10, a single item of sports memorabilia or segments thereof may be authenticated according to the present invention in a manner similar to that used to authenticate autographed items at a private signing event. Although the method and system of the present application may be used to authenticate any type of sports memorabilia, preferred items include, but are not limited to, segments 70A of the game-worn jersey 70 of a well-known athlete (see FIG. 9), and segments 72A cut from the net of a basketball goal 72 used in a tournament (see FIG. 10).

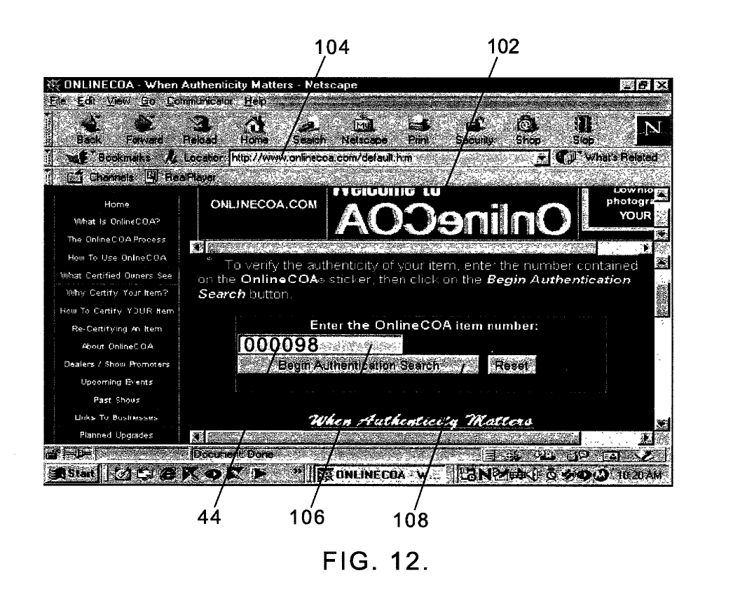

Each item 70 and 72, and respective segments 70A and 72A, are authenticated in a manner similar to that in which items obtained at a private signing event are authenticated. To authenticate an item or each of its corresponding segments, digital data is first gathered showing the item before it has been cut or otherwise divided into individual segments, and then showing the item being divided into segments. The digital data includes, but is not limited to digital photographs, streaming digital video, streaming digital audio and the like, which is later used to document the authentication process (see FIG. 15). Once the item is divided into segments and digital data and identifying information related to the item and segments are gathered, a certification card like the certification card 50 shown in FIG. 6, is created for each segment. In addition, a unique tracking number and password are assigned to each segment. Like the password 34, the password assigned to a segment is later used by the owner of the segment to enter a Web site for accessing digital data documenting the authenticity of the segment (see FIG. 12).

Each segment and corresponding certification card is then labeled with a respective one of two labels. Each of the labels includes the same components and is formed in the same manner as the labels 42A and 42B described above and shown in FIGS. 4 and 5, respectively. The tracking number assigned to the segment is printed on the prismatic surface of each of the two labels. One of the labels is attached to the surface of the segment in a manner similar to that shown in FIG. 5, and the other of the labels is attached to the certification card (see FIG. 6). Like the certification card 50 shown in FIG. 6, the certification card associated with the authenticated segment preferably also includes identifying information and information regarding the procedure to be followed in the event a subsequent transfer of ownership takes place.

Downloading and Accessing Digital Data

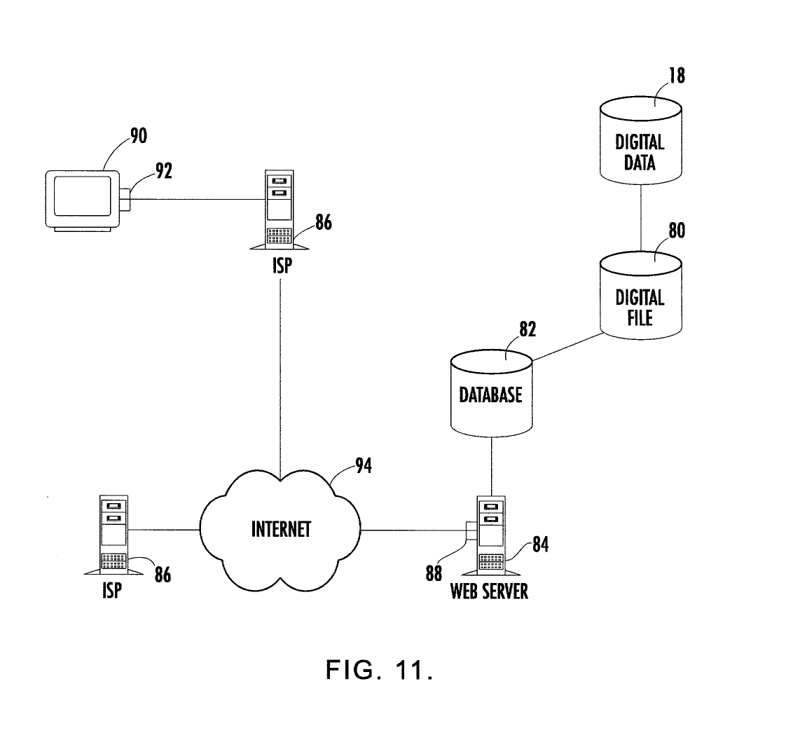

Referring now to FIG. 11, a flow chart is shown depicting the manner in which the digital data gathered by the authentication company or organization during an interactive event is made available to, and is accessed by, an owner or other requesting party using the Internet. Although the flow chart shown in FIG. 11 uses the steps and elements required for authenticating an item autographed at a public signing event as described above in reference to FIGS. 1 through 8, the steps and elements presented in FIG. 11 are also applicable to digital data gathered at a private signing event or at an event during which the authenticity of an item or its corresponding segments has been documented.

Turning now to FIG. 11 and using digital data 18 as a representative example, the digital data 18 documenting each item 20 is downloaded to at least one digital file 80, which is then downloaded to a database 82 and made available to the owner or other authorized requesting party from a system Web server 84 using one or more Internet service providers (“ISPs”) 86 and standard communications equipment 88. Each owner or other requesting party may access the digital file 80 from an interface 90 using any ISP 86 and suitable communications equipment, such as a modem 92. The interface 90 may be any suitable information technology hardware and/or software used for accessing the Internet 94, such as a personal computer equipped with a Web browser capable of reading computer markup language, such as HTML and Dynamic-HTML.

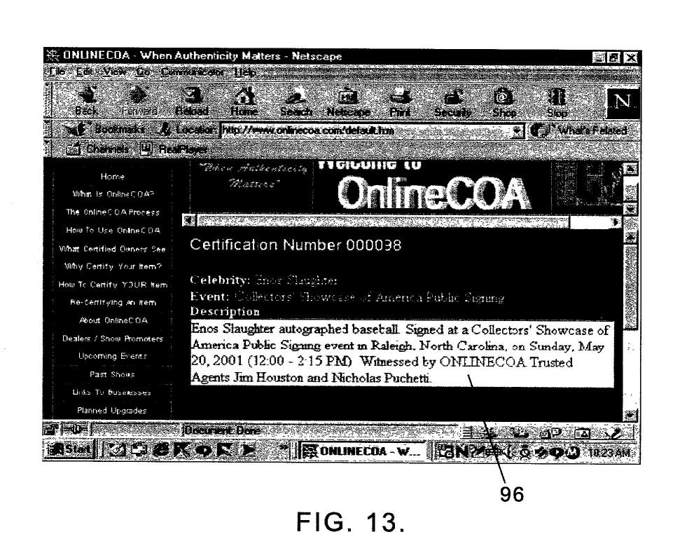

Although the digital data 18 gathered by the authentication company 12 may be downloaded to the database 82 and made available through the Internet 94 at any time after the close of the corresponding interactive event, the digital data 18 is preferably assembled into individual data files 80 and downloaded to the database 82 within 48 hours after the close of the event. Each digital file 80 includes digital data 18 representing textual information 96 describing a respective one of the autographed items 20 including but not limited to a brief description of the autographed item 20, the name of the celebrity 19 who autographed the item, the name of the sponsor or other host of the event 14, the date, time and location of the event 14, and the name(s) of the authentication company representative(s) who performed the authentication process. An example of textual information data 96 available in a digital file 80 is shown in FIG. 13.

In addition to textual information data 96 related specifically to a respective one of the autographed items 20, digital data 18 including digital photographs 24 depicting the autographed item 20, the autograph ticket 22, and the holographic labels 42A and 42B associated therewith (see FIGS. 4 and 5) are downloaded into the digital file 80. These digital photographs 24, along with textual information data 96 (see FIG. 13), serve as documentation verifying that the images of the item 20 and the information set forth on the certification card 50 (see FIG. 6) and ownership history 60 (see FIG. 7) are consistent and accurate. The digital photographs 24 of the autographed item 20 also accurately document any inscriptions that the celebrity may have added to the autographed item, such as the Hall of Fame (“H.O.F.”) inscription 100 set forth on the baseball shown in FIG. 4.

In addition to downloading photographs 24 and textual information 96 relating specifically to the autographed item 20 into the individual data file 80, multiple “generic” digital photographs such as the photograph 24A depicted in FIG. 4 and showing the celebrity 19 autographing a like item are downloaded into the individual data file 80 for use as additional evidence verifying that the event 14 actually occurred and that the celebrity 19 was physically present at the event 14 and did, in fact, autograph items like the authenticated item 20 depicted in the digital file 80.

Referring now to FIGS. 12 through 16, the manner in which the owner or another authorized representative of an item 20 authenticated using a preferred method and system of the present invention use the Internet 94 to access digital data 18 stored in a digital file 80 is shown. FIG. 12 illustrates a screen shot of the home page 102 of a Web site 104 used for verifying the authenticity of autographed items and other sports memorabilia and segments thereof. The Web site 104 is created and maintained on the Web server 84, and is accessible on the Internet 94 using any suitable interface 90 and ISP 86 as described above in reference to FIG. 11.

Referring again to FIG. 12, and using an autographed item 20 which has been authenticated at a public signing event as a representative example, in order to access the digital data 18, the owner of the authenticated item 20 first enters the tracking number 44 corresponding to the item 20 into a designated entry field 106 provided on the home page 102. The owner then uses a computer mouse or other suitable guidance tool to “double-click” or otherwise activate the button 108 labeled “Begin Authentication Search”. As shown in FIG. 13, the Web site 104 responds by generating textual information data 96 describing the authenticated item 20. The owner is then prompted to enter the password 34 originally assigned to the item 20 at the time the item 20 was originally authenticated or otherwise recertified. FIG. 14 illustrates a representative example of a textual description 108 of the password prompt.

Upon correct entry of the password 34, a full authentication history 112 such as the representative example illustrated in FIG. 15 is displayed on the Web site 104. Each official authentication history 112 includes a textual description 96 identical to that shown in FIG. 13. The history 112 also includes one or more digital photograph hyperlinks 114A, 114B and 114C, a streaming digital video and audio hyperlink 116, and a hyperlink 118 containing data depicting the certified ownership history document 50 originally provided to the owner at the interactive event 14. Each hyperlink 114A, 114B, 114C, 116 and 118, respectively, is available to the owner for use in verifying the authenticity of an autographed item 20, any other item of sports memorabilia or a segment thereof, an autograph ticket 22, and/or a certified ownership history document 50 obtained by the owner during an interactive event 14. The hyperlinks 114A, 114B, and 114C permit the owner to download a respective one of three different streaming digital photographs 24 pertaining to the item 20 and similar to the photographs 24 illustrated in FIG. 3. Hyperlink 116 permits the owner to download at least one file containing streaming digital video and audio data, 26 and audio 28, respectively, related to the authenticated item 20 and to the digital video 26 and audio 28 data provided to the owner at the interactive event 14. The certified ownership history 50 may be downloaded using hyperlink 118. Although five hyperlinks 114A, 114B, 114C, 116 and 118, respectively, and are shown in FIG. 15, any suitable number of hyperlinks may be associated with a single authenticated item 20.

A method and system for verifying the authenticity of a preselected item is disclosed. Various details of the invention may be changed with departing from its scope. Furthermore, the foregoing description of the preferred embodiment of the invention and the best mode for practicing the invention are provided for the purpose of illustration only and not for the purpose of limitation—the invention being defined by the claims.

We claim:

1. A method for verifying the authenticity of a preselected item, comprising:
(a) selecting authenticating indicia for association with the preselected item;
(b) associating said authenticating indicia with the preselected item;
(c) generating digital data containing evidence of the preselected item and the authenticating indicia associated therewith;
(d) generating a digital file containing said digital data;
(d) downloading said digital file to a server associated with the Internet using software downloaded to a computer associated with the server for permitting the digital data to be accessed from the Internet using Internet data accessing techniques; and
(e) providing a Web site maintained by an authenticating party and accessible by a requesting party using the Internet data accessing techniques for permitting the requesting party to retrieve the digital file and confirm the authenticity of the preselected item.

2. A method according to claim 1, wherein the step of generating digital data further comprises the step of providing an interactive event to provide a forum for authenticating the preselected item.

3. A method according to claim 1 or 2, wherein the step of providing said Web site further comprises providing a preselected password to the requesting party for permitting the requesting party to access the Web site.

4. A method according to claim 1, wherein the digital data is selected from the group consisting of a digital photograph, digital streaming video, digital streaming audio, and supporting textual information.

5. A method according to claim 1, wherein the digital data comprises:
(a) at least one digital photograph;
(b) digital streaming video;
(c) digital streaming audio; and
(d) supporting textual information.

6. A method according to claim 1, wherein the preselected item comprises an autographed item.

7. A method according to claim 1, wherein the preselected item comprises a three-dimensional object.

8. A method according to claim 7, wherein said three-dimensional object comprises an athletic item.

9. A method according to claim 8, wherein said athletic item is selected from the group consisting of a ball, a garment, and an implement.

10. An authentication model, comprising:
(a) an interactive event administered by an authenticating party for providing a forum in which at least one preselected item is authenticated by associating authenticating indicia with the preselected item;
(b) digital data generated during said interactive event for documenting the association of said authenticating indicia with the preselected item;
(c) at least one digital file containing said digital data and downloaded to a server associated with the Internet using software downloaded to a computer associated with the server for permitting the digital data to be accessed from the Internet using common Internet data accessing techniques; and
(d) an on-line Web site maintained by the authenticating party and accessible by a requesting party using the Internet data accessing techniques for retrieving said at least one digital file, thereby confirming the authenticity of the preselected item.

11. A model according to claim 10, and including a preselected password provided by the authenticating party to the requesting party for permitting the requesting party to access said Web site.

12. A model according to claim 10, wherein the digital data is selected from the group consisting of a digital photograph, digital streaming video, digital streaming audio, and supporting textual information.

13. A model according to claim 10, wherein the digital data comprises:
(a ) at least one digital photograph;
(b) digital streaming video;
(c) digital streaming audio; and
(d) supporting textual information.

14. A model according to claim 10, wherein the preselected item comprises an autographed item.

15. A model according to claim 10, wherein the preselected item comprises a three-dimensional object.

16. A model according to claim 10, wherein said three-dimensional object comprises an athletic item.

17. A model according to claim 16, wherein said athletic item is selected from the group consisting of a ball, a garment, and an implement.
